(19) United States
(12) Patent Application Publication
(10) Pub. No.: US 2014/0096751 A1
(43) Pub. Date: Apr. 10, 2014

(54) EXHAUST GAS RECIRCULATION COOLER FOR VEHICLE

(71) Applicants: HYUNDAI MOTOR COMPANY, Seoul (KR); KIA MOTORS CORPORATION, Seoul (KR)

(72) Inventor: Ji-Ro Chu, Suwon-si (KR)

(73) Assignees: Kia Motors Corporation, Seoul (KR); Hyundai Motor Company, Seoul (KR)

(21) Appl. No.: 13/648,824

(22) Filed: Oct. 10, 2012

(51) Int. Cl. F02M 31/20; F02M 25/07

(52) U.S. Cl. 123/568.12

(57) ABSTRACT

An EGR (Exhaust Gas Recirculation) cooler apparatus for a vehicle may include a main cooling unit that may be disposed on an EGR line recirculating exhaust gas from an exhaust manifold to an intake manifold to cool the exhaust gas through coolant, a valve assembly that may be connected to the main cooling unit to control exhaust gas flowing rate supplied to the main cooling unit, and a sub cooling unit that may be integrally formed on the main cooling unit and cools down the exhaust gas that may be to be supplied to the valve assembly.

### CROSS-REFERENCE TO RELATED APPLICATION

The present application claims priority to Korean Patent Application No. 10-2011-0105441 filed on Oct. 14, 2011, the entire contents of which is incorporated herein for all purposes by this reference.

### BACKGROUND OF THE INVENTION

1. Field of the Invention

An exemplary embodiment of the present invention is related to an exhaust gas recirculation system of a vehicle (hereinafter, for convenience “EGR”. More particularly, the present invention relates to an EGR cooler that cools exhaust gas that is recirculated from an exhaust manifold to an intake manifold of an engine.

2. Description of Related Art

Generally, in an EGR system of a vehicle, a part of the exhaust gas exhausted from an engine is circulated to an intake side of an engine to be supplied into a combustion chamber such that oxygen concentration of an intake air is reduced to deteriorate the max combustion temperature and CO2 diluting NOx is increased to suppress the NOx generation.

FIG. 1A and FIG. 1B is a block diagram that schematically shows an EGR system for a vehicle according to a conventional art.

Referring to FIG. 1A, an EGR system 300 for a vehicle according to a conventional art includes a turbo charger 4 that uses energy of exhaust gas that is exhausted from an exhaust manifold of an engine 1 to compress intake air that is supplied to an intake manifold 3.

Here, the turbo charger 4 includes a turbine 5 that is disposed on an exhaust line of an engine and a compressor 6 that is connected to the turbine 5 through a shaft to be disposed on an intake line.

And, the EGR system 300 includes an EGR line 7 that connects an upstream side of the turbine 5 to the intake manifold 3 to recirculate exhaust gas of the exhaust manifold 2 to the intake manifold 3.

An EGR cooler 400 is disposed thereon so as to cool the high temperature exhaust gas passing the EGR line 7 to a predetermined low temperature, and an EGR valve 101 is disposed at an upstream side of the EGR cooler 400 so as to control the exhaust gas flowing amount.

Accordingly, the high temperature exhaust gas that flows through the EGR line 7 passes the EGR valve 101 and is supplied to the EGR cooler 400 to be cooled by coolant of the cooler to a predetermined low temperature.

However, in the conventional art, when the temperature of the exhaust gas that flows through the EGR valve 101 through the EGR line 7 is excessively high, the durability of the EGR valve 101 can be deteriorated by the high temperature of exhaust gas.

The EGR valve 101 can be disposed at a downstream side of the EGR cooler 400 so as to prevent this in a conventional art as described in another exemplary embodiment of FIG. 1B.

Thus, the high temperature exhaust gas is supplied to the EGR cooler 400 to be cool by coolant to a predetermined low temperature, and then passes the EGR valve 101 to be supplied to the intake manifold 3.

However, it is advantageous for the durability of the EGR valve 101, because the exhaust gas that is to be supplied to the EGR valve 101 is cooled by the EGR cooler 400. However, a predetermined amount of exhaust gas is remained in the EGR cooler 400 to generate condensate, the condensate can be supplied to the combustion chamber of the engine 1, and the EGR cooler 400 can be damaged by the freezing of the condensate.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an EGR cooler for a vehicle having advantages of cooling exhaust gas that is supplied to an EGR valve through coolant, wherein the exhaust gas flows from an exhaust line of an engine to an intake line.

In an aspect of the present invention, an EGR (Exhaust Gas Recirculation) cooler apparatus for a vehicle, may include a main cooling unit that is disposed on an EGR line recirculating exhaust gas from an exhaust manifold to an intake manifold to cool the exhaust gas through coolant, a valve assembly that is connected to the main cooling unit to control exhaust gas flowing rate supplied to the main cooling unit, and a sub cooling unit that is integrally formed on the main cooling unit and cools down the exhaust gas that is to be supplied to the valve assembly.

The sub cooling unit is disposed upstream of the main cooling unit and cools down the exhaust gas that is to be supplied to the valve assembly ahead.

The main cooling unit may include a main body that the coolant and the exhaust gas respectively flow through, wherein the main body may include a coolant passage through which the coolant flows, and a first exhaust gas passage formed adjacent to the coolant passage, wherein the exhaust gas passing the valve assembly flows through the first exhaust gas passage.

The sub cooling unit may include a passage member that is formed adjacent to the coolant passage of the main body and circulates the exhaust gas that is to be supplied to the valve assembly from the exhaust manifold.

The sub cooling unit may include a passage member that is formed adjacent to the coolant passage of the main body and circulates the exhaust gas that is supplied to the valve assembly from the exhaust manifold, wherein the passage member is integrally formed with the main body and may include a second exhaust gas passage that receives and circulates the exhaust gas.

The main body may include coolant inlet and coolant outlet that are respectively connected to the coolant passage at upstream and downstream thereof, an exhaust gas inlet that is connected to the second exhaust gas passage and supplies the exhaust gas that is to be supplied to the valve assembly to the passage member, and an exhaust gas outlet that is connected to the first exhaust gas passage and discharges the exhaust gas that passes the second exhaust gas passage and the first exhaust gas passage to the intake manifold.

The sub cooling unit may include a passage member that is formed adjacent to the coolant passage of the main body and circulates the exhaust gas that is supplied to the valve assembly from the exhaust manifold, wherein the passage member that is integrally formed with the main body may include a second exhaust gas passage circulating the exhaust gas and the second exhaust gas passage is connected to the first exhaust gas passage through the valve assembly, and wherein the main body may include coolant inlet and coolant outlets that are respectively connected to the coolant passage at upstream and downstream thereof, an exhaust gas inlet that is connected to the second exhaust gas passage and supplies the exhaust gas that is to be supplied to the valve assembly to the passage member, and an exhaust gas outlet that is connected to the first exhaust gas passage and discharges the exhaust gas that passes the second exhaust gas passage and the first exhaust gas passage to the intake manifold.

Accordingly, another aspect of the present invention cools down the high temperature exhaust gas by the sub cooling unit ahead, wherein the exhaust gas is recirculated from an exhaust line of the engine to an intake line to be supplied to the valve assembly and prevents the durability deterioration of the valve assembly.

And, although the valve assembly is disposed at a downstream side of the main cooling unit, the durability deterioration of the valve assembly is prevented by the sub cooling unit in an exemplary embodiment of the present invention.

Also, the condensate problem that can be generated in a condition that the valve assembly is disposed at a downstream side of the main cooling unit in a conventional art can be resolved in an exemplary embodiment of the present invention.

And, the sub cooling unit is integrally formed with the main cooling unit in an exemplary embodiment of the present invention such that the layout of the EGR system is not varied, number of components of the entire system is reduced, and the engine system becomes compact.

Also, while the main body is being casted, the position of the passage member of the sub cooling unit is adjusted to be able to change the cross section shape of the second exhaust gas passage that the exhaust gas flows through, and therefore the temperature of the exhaust gas flowing thorough the valve assembly can be effectively controlled.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B is a block diagram that schematically shows an EGR system for a vehicle according to a conventional art.

FIG. 2 is a block diagram that schematically shows an EGR system that is applied to an EGR cooler for a vehicle according to an exemplary embodiment of the present invention.

FIG. 3 is a partially cut perspective view that shows an EGR cooler for a vehicle according to an exemplary embodiment of the present invention.

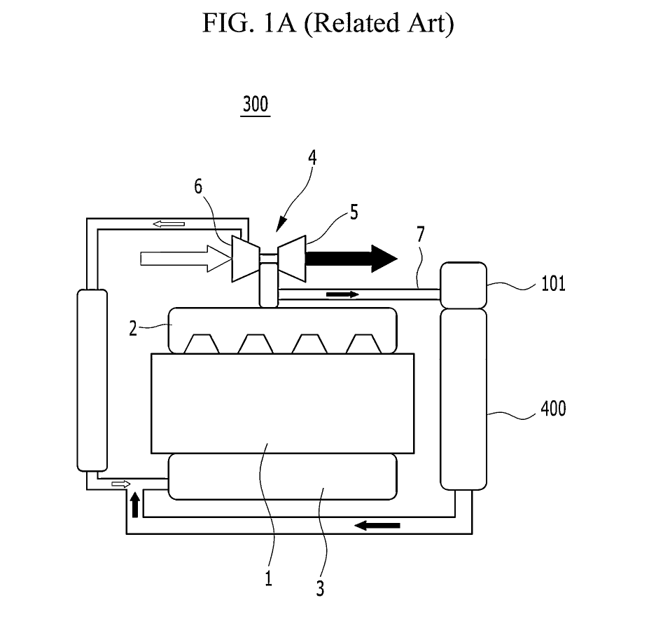

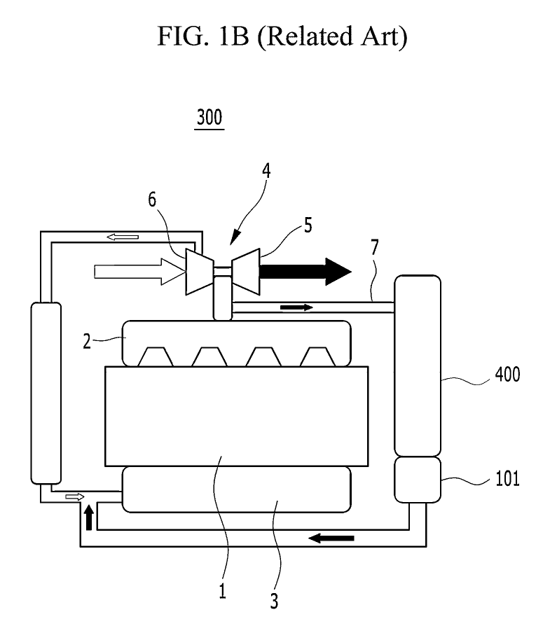

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

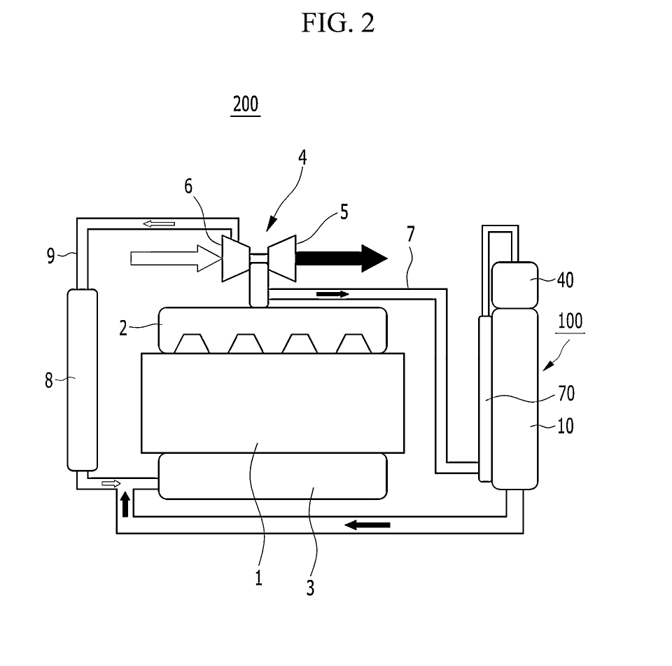

FIG. 2 is a block diagram that schematically shows an EGR system that is applied to an EGR cooler for a vehicle according to an exemplary embodiment of the present invention.

Referring to FIG. 2, an EGR cooler 100 for a vehicle according to an exemplary embodiment of the present invention can be applied to an exhaust gas recirculation system 200 (hereinafter, for convenience “EGR”) that recirculates exhaust gas from an exhaust manifold 2 to an intake manifold 3 to reduce NOx of exhaust gas.

For example, the EGR system 200 includes a turbo charger 4 that uses exhaust gas energy of an exhaust manifold of an engine 1 to compress intake air that is suctioned through an intake manifold 3.

Here, the turbo charger 4 includes a turbine 5 that is disposed on an exhaust line of an engine 1 and a compressor 6 that is connected to the turbine 5 through a shaft to be disposed on an intake line.

The turbo charger 4 has been known to a person skilled in the art, and therefore the further detailed description thereof will be omitted in this specification.

And, the EGR system 200 includes an EGR line 7 that connects an upstream side of the turbine 5 with the intake manifold 3 and recirculates exhaust gas of the exhaust manifold 2 to the intake manifold 3.

An EGR cooler 100 is disposed on the EGR line 7 according to an exemplary embodiment of the present invention, and the EGR cooler 100 is used to cool the high temperature exhaust gas that flows through the EGR line 7 to a predetermined value.

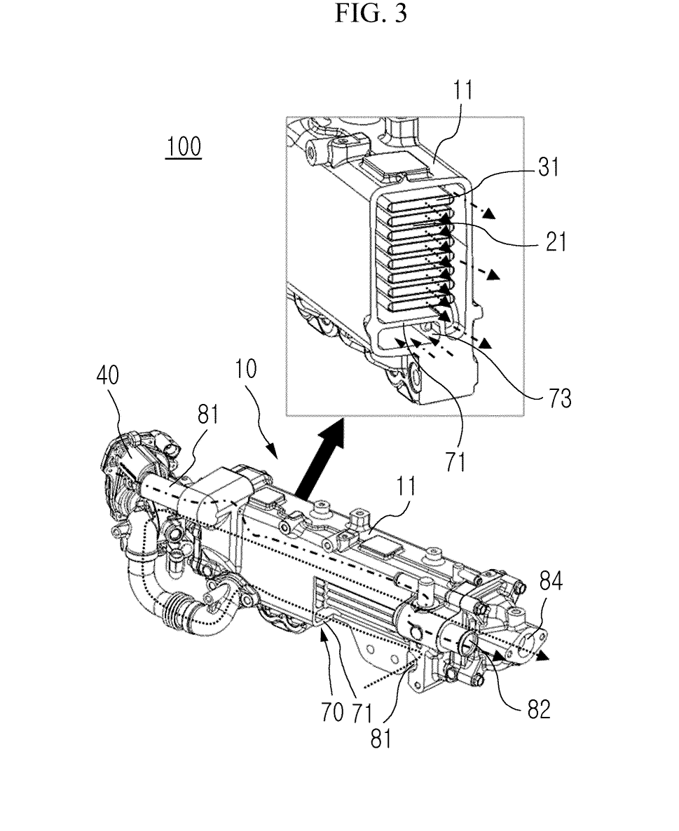

The EGR cooler 100 according to an exemplary embodiment of the present invention will be described with reference to FIG. 3.

A non-described drawing number 8 in the drawing denotes an intercooler that is disposed on the intake line 9 that connects the intake manifold 3 with a compressor 6 of a turbo charger 4.

FIG. 3 is a partially cut perspective view that shows an EGR cooler for a vehicle according to an exemplary embodiment of the present invention.

Referring to FIG. 2 and FIG. 3, the EGR cooler 100 according to an exemplary embodiment of the present invention includes a main cooling unit 10, a valve assembly 40, and a sub cooling unit 70, and these are described as follows.

In an exemplary embodiment of the present invention, the main cooling unit 10 is used to cool exhaust gas that is recirculated from an exhaust to an intake of an engine 1 and include a main body 11 that respectively circulates coolant and exhaust gas.

The main body 11 includes a coolant passage 21 that coolant flows therethrough and a first exhaust gas passage 31 that exhaust gas that is formed near the coolant passage 21 such that the exhaust gas that passes a valve assembly 40 flows along the coolant passage 21.

Here, the coolant passage 21 is formed in the main body 11 and has a water core type that the coolant can flow therethrough.

And, the first exhaust gas passage 31 is disposed on the coolant passage 21 and has a multi layered tube that circulates exhaust gas that is supplied from exhaust line of an engine 1 and passes the valve assembly 40.

In an exemplary embodiment of the present invention, the valve assembly 40 includes an EGR valve that controls the exhaust gas flow amount that is supplied to the first exhaust gas passage 31 of the main cooling unit 10.

The valve assembly 40 is connected to one end of the main body 11 and a valve passage thereof is connected to the first exhaust gas passage 31.

The valve assembly 40 is applied to an EGR system, is be able to be operated by a DC motor or a hydraulic (air) actuator, and the further detailed description thereof will be omitted in this specification.

In an exemplary embodiment of the present invention, the sub cooling unit 70 is used to cool the exhaust gas that is to be supplied to the valve assembly 40.

That is, the high temperature exhaust gas that is to be supplied to the valve assembly 40 is cooled ahead by the coolant through the sub cooling unit 70 in an exemplary embodiment of the present invention, and therefore the durability of the valve assembly 40 can be enhanced.

More specifically, although the valve assembly 40 is disposed at an upstream side of the main, the durability of the valve assembly 40 is not deteriorated by the sub cooling unit 70 in an exemplary embodiment of the present invention.

And, the problem of the condensate that can be generated in a condition that the valve assembly 40 is disposed at a downstream side of the main cooling unit 10 in a conventional art can be resolved in an exemplary embodiment of the present invention.

For this, the sub cooling unit 70 is integrally formed with the main cooling unit 10 to be formed along the coolant passage 21 of the main body 11 and includes a passage member 71 that circulates exhaust gas from an exhaust line of the engine 1 to the valve assembly 40.

The passage member 71 is integrally casted on the main body 11 of the main cooling unit 10 to form a second exhaust gas passage 73 that circulates the exhaust gas to the valve assembly 40.

In this case, the second exhaust gas passage 73 is connected to the first exhaust gas passage 31 of the main cooling unit 10 through the valve assembly 40, and can be connected to another valve passage of the valve assembly 40.

Here, the passage member 71 is integrally formed in the main body 11 and has a barrier wall shape forming the second exhaust gas passage 73, and a cross section of the second exhaust gas passage 73 can be adjusted by moving the position of the barrier wall during casting of the main body 11.

As describe above, the cross section shape adjustment of the second exhaust gas passage 73 signifies that the exhaust gas temperature that is supplied to the valve assembly 40 can be controlled.

Meanwhile, the main body 11 includes a coolant inlet 81 and a coolant outlet 82 that is respectively connected to a coolant passage 21.

And, the main body 11 includes an exhaust gas inlet 83 that is connected to the second exhaust gas passage 73 of the passage member 71 and circulates exhaust gas that is supplied from an exhaust line of an engine 1 to the valve assembly 40 to the second exhaust gas passage 73 of the passage member 71.

Also, the main body 11 includes an exhaust gas outlet 84 that is connected to the first exhaust gas passage 31, and the exhaust gas outlet 84 discharges exhaust gas that passes the second exhaust gas passage 73 of the passage member 71 and the first exhaust gas passage 31.

Accordingly, in the EGR cooler for a vehicle 100 according to an exemplary embodiment of the present, the EGR system 200 can compress the intake air that is suctioned to an intake manifold 3 through the turbo charger 4.

That is, the turbo charger 4 uses exhaust gas energy that is exhausted from the exhaust manifold 2 of the engine 1 to be able to compress the intake air that is suctioned to the intake manifold 3.

In this process, the exhaust gas that is exhausted from the exhaust manifold 2 is recirculated to the intake manifold 3 through the EGR line 7 to be supplied to the passage member 71 of the sub cooling unit 70 through the exhaust gas inlet 83 of the main body 11.

In this case, the coolant flows through the coolant passage 21 inside the main body 11, and the coolant is supplied to the coolant passage 21 through the coolant inlet 81 of the main body 11 to be discharged through the coolant outlet 82.

In the above condition, the high temperature exhaust gas circulating the EGR line 7 flows through the second exhaust gas passage 73 of the passage member 71 to be cooled down by the coolant flowing the coolant passage 21 to a predetermined low temperature.

The exhaust gas that is cooled by the coolant is supplied to the valve assembly 40 and then is supplied to the first exhaust gas passage 31.

Accordingly, the exhaust gas flows through the first exhaust gas passage 31 to be cooled down by the coolant flowing through the coolant passage 21 to a predetermined temperature, and then can be discharged through the exhaust gas outlet 84 of the main body 11.

As described above, in the EGR cooler for a vehicle 100 according to an exemplary embodiment of the present invention, the exhaust gas that circulates from an exhaust line of the engine 1 to an intake line through the EGR line 7 can be cooled down by the sub cooling unit 70 ahead.

Thereby, the high temperature exhaust gas that is recirculated from an exhaust line of the engine 1 to an intake line to be supplied to the valve assembly 40 is cooled down by the sub cooling unit 70 ahead such that the durability deterioration of the valve assembly 40 is prevented in an exemplary embodiment of the present invention.

Accordingly, although the valve assembly 40 is disposed at a downstream side of the main cooling unit 10, the durability deterioration of the valve assembly 40 is prevented by the sub cooling unit 70 in an exemplary embodiment of the present invention.

Also, the condensate problem that can be generated in a condition that the valve assembly 40 is disposed at a downstream side of the main cooling unit 100 in a conventional art can be resolved in an exemplary embodiment of the present invention.

And, the sub cooling unit 70 is integrally formed with the main cooling unit 10 in an exemplary embodiment of the present invention such that the layout of the EGR system 200 is not varied, number of components of the entire system is reduced, and the engine system becomes compact.

Also, while the main body 11 is being casted, the position of the passage member 71 of the sub cooling unit 70 is adjusted to be able to change the cross section shape of the second exhaust gas passage 73 that the exhaust gas flows through, and therefore the temperature of the exhaust gas flowing thorough the valve assembly 40 can be effectively controlled.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An EGR (Exhaust Gas Recirculation) cooler apparatus for a vehicle, comprising:
a main cooling unit that is disposed on an EGR line recirculating exhaust gas from an exhaust manifold to an intake manifold to cool the exhaust gas through coolant;
a valve assembly that is connected to the main cooling unit to control exhaust gas flowing rate supplied to the main cooling unit; and
a sub cooling unit that is integrally formed on the main cooling unit and cools down the exhaust gas that is to be supplied to the valve assembly.

2. The EGR cooler apparatus for the vehicle of claim 1, wherein the sub cooling unit is disposed upstream of the main cooling unit and cools down the exhaust gas that is to be supplied to the valve assembly ahead.

3. The EGR cooler apparatus for the vehicle of claim 1, wherein the main cooling unit includes a main body that the coolant and the exhaust gas respectively flow through,
wherein the main body includes:
a coolant passage through which the coolant flows; and
a first exhaust gas passage formed adjacent to the coolant passage, wherein the exhaust gas passing the valve assembly flows through the first exhaust gas passage.

4. The EGR cooler apparatus for the vehicle of claim 3, wherein the sub cooling unit includes a passage member that is formed adjacent to the coolant passage of the main body and circulates the exhaust gas that is to be supplied to the valve assembly from the exhaust manifold.

5. The EGR cooler apparatus for the vehicle of claim 3, wherein the sub cooling unit includes a passage member that is formed adjacent to the coolant passage of the main body and circulates the exhaust gas that is supplied to the valve assembly from the exhaust manifold,
wherein the passage member is integrally formed with the main body and includes a second exhaust gas passage that receives and circulates the exhaust gas.

6. The EGR cooler apparatus for the vehicle of claim 5, wherein the main body includes
coolant inlet and coolant outlet that are respectively connected to the coolant passage at upstream and downstream thereof,
an exhaust gas inlet that is connected to the second exhaust gas passage and supplies the exhaust gas that is to be supplied to the valve assembly to the passage member, and
an exhaust gas outlet that is connected to the first exhaust gas passage and discharges the exhaust gas that passes the second exhaust gas passage and the first exhaust gas passage to the intake manifold.

7. The EGR cooler apparatus for the vehicle of claim 3, wherein the sub cooling unit includes a passage member that is formed adjacent to the coolant passage of the main body and circulates the exhaust gas that is supplied to the valve assembly from the exhaust manifold,
wherein the passage member that is integrally formed with the main body includes a second exhaust gas passage circulating the exhaust gas and the second exhaust gas passage is connected to the first exhaust gas passage through the valve assembly.

8. The EGR cooler apparatus for the vehicle of claim 7, wherein the main body includes
coolant inlet and coolant outlets that are respectively connected to the coolant passage at upstream and downstream thereof,
an exhaust gas inlet that is connected to the second exhaust gas passage and supplies the exhaust gas that is to be supplied to the valve assembly to the passage member, and
an exhaust gas outlet that is connected to the first exhaust gas passage and discharges the exhaust gas that passes the second exhaust gas passage and the first exhaust gas passage to the intake manifold.
